(19) United States
(12) Patent Application Publication
(10) Pub. No.: US 2022/0062998 A1
(43) Pub. Date: Mar. 3, 2022

(54) NOVEL ARCHITECTURES FOR HIGH-THROUGHPUT ADDITIVE MANUFACTURING

(71) Applicant: Apple Inc., Cupertino, CA (US)

(72) Inventors: Robert W. Hyers, Winchester, MA (US); James A. Yurko, Saratoga, CA (US); Eric W. Hamann, Santa Clara, CA (US); Brian M. Gable, San Jose, CA (US)

(21) Appl. No.: 17/444,586

(22) Filed: Aug. 6, 2021

Related U.S. Application Data
(60) Provisional application No. 63/071,078, filed on Aug. 27, 2020.

(51) Int. Cl. B22F 12/49; B33Y 10/00; B33Y 30/00; B28B 1/00; B22F 10/28; B22F 12/41; B22F 12/45

(52) U.S. Cl. CPC B22F 12/49; B33Y 10/00; B33Y 30/00; B22F 12/45; B22F 10/28; B22F 12/41; B28B 1/001

(57) ABSTRACT

A method of forming a part can include selectively activating one or more lasers of a laser array comprising at least 100 lasers based at least partially on a geometry of the part being formed. The method can further include scanning laser spots over a powder bed, the laser sports generated by the activated lasers, and selectively sintering a powder contained in the powder bed with the laser spots to form the part.

### CROSS-REFERENCE TO RELATED APPLICATION(S)

This claims priority to U.S. Provisional Patent Application No. 63/071,078, filed 27 Aug. 2020, and entitled “NOVEL ARCHITECTURES FOR HIGH-THROUGHPUT ADDITIVE MANUFACTURING,” the entire disclosure of which is hereby incorporated by reference.

### FIELD

The described embodiments relate generally to systems and methods of forming parts using high-throughput additive manufacturing. More particularly, the present embodiments relate to using novel architectures for systems to enable high-throughput additive manufacturing.

### BACKGROUND

Electronic devices are widespread in society and can take a variety of forms, from wristwatches to computers. Electronic devices, including portable electronic devices such as handheld phones, tablet computers, and watches, generally include a type of housing or enclosure to house the internal components.

Often, the housing or enclosures are relatively complicated components, including fine surface finishes, complex geometries, and intricate features that are used to enhance the function and performance of the electronic devices. The manufacture of such enclosures or housings using traditional methodologies can be labor intensive, require multiple machining and polishing steps, and result in relatively large quantities of material waste.

Recent advances in additive manufacturing processes offer unique opportunities to make electronic device housings and other parts and components while reducing subtractive manufacturing steps and material waste. Traditional additive manufacturing processes, however, can be extremely slow, preventing production of such 3D printed enclosures in large volumes. Accordingly, it can be desirable to provide a high-throughput additive manufacturing technique that allows for large volume production.

### SUMMARY

According to some aspects of the present disclosure, a method of forming a part using an additive manufacturing process can include selectively activating one or more lasers of a laser array comprising at least 100 lasers based at least partially on a geometry of the part being formed, scanning laser spots over a powder bed, the laser sports generated by the activated lasers, and selectively sintering a powder contained in the powder bed with the laser spots to form the part.

In some examples, scanning the laser spots comprises moving the laser spots in a direction parallel to a common plane of the laser spots. The part is formed at a rate of greater than about 10,000 cm³/hour. Scanning the laser spots includes moving the powder bed relative to the laser spots. The laser spots include two or more different spot sizes. The part includes a housing for an electronic device. Selectively sintering the powder includes simultaneously forming multiple melt pools in the powder. The powder includes at least one of steel, cobalt, chromium, aluminum, titanium, gold, platinum, silver, or ceramic. The powder includes particles having an average major dimension between about 10 microns and about 200 microns.

According to some examples, an additive manufacturing system can include a laser array including at least 100 lasers, a powder bed to contain a sinterable powder, at least one of the powder bed or a portion the laser array moveable relative to the other of the powder bed and the portion of the laser array, a controller to selectively activate lasers based at least in part on a desired geometry of a part.

In some examples, the laser array generates laser spots having a spot size of about 20 microns to about 200 microns. The laser array has a collective output power of about 50 kilowatts to about 500 kilowatts. The laser array includes two or more rows of laser heads. The laser array includes a reflecting element to direct radiation generated by the lasers to desired locations on the powder bed.

According to some examples, a 3D printer can include a powder bed, and a laser array including at least 100 lasers to selectively generate laser spots at desired locations on the powder bed, the desired locations extending across a major dimension of the powder bed, and at least one of the powder bed or the desired locations moveable relative to the other of the powder bed and the desired locations.

In some examples, the laser array includes fiber optics to direct radiation from the lasers to the desired locations. The laser array includes between 100 and 1,000 lasers. A laser can is independently translatable relative to the powder bed. The laser array includes multiple rows of laser heads.

### BRIEF DESCRIPTION OF THE DRAWINGS

The disclosure will be readily understood by the following detailed description in conjunction with the accompanying drawings, wherein like reference numerals designate like structural elements, and in which:

FIG. 1A shows a perspective view of an electronic device.

FIG. 1B shows an exploded view of the electronic device of FIG. 1A.

FIG. 1C shows a perspective view of an enclosure of the electronic device of FIG. 1A.

FIG. 2A shows a perspective view of an electronic device.

FIG. 2B shows an exploded view of the electronic device of FIG. 2A.

FIG. 2C shows a perspective view of an enclosure of the electronic device of FIG. 2A.

FIG. 3A shows a perspective view of an electronic device.

FIG. 3B shows an exploded view of the electronic device of FIG. 3A.

FIG. 3C shows a cross-sectional view of an enclosure of the electronic device of FIG. 3A.

FIG. 4A shows a perspective view of an electronic device.

FIG. 4B shows an exploded view of the electronic device of FIG. 4A.

FIG. 4C shows a perspective view of an enclosure of the electronic device of FIG. 4A.

FIG. 5 shows a top view of an additive manufacturing system including a laser array and powder bed.

FIG. 6A shows a front sectional view of an additive manufacturing system at a stage of an additive manufacturing process.

FIG. 6B shows a front sectional view of the additive manufacturing system of FIG. 6A at a stage of an additive manufacturing process.

FIG. 6C shows a front sectional view of the additive manufacturing system of FIG. 6A at a stage of an additive manufacturing process.

FIG. 6D shows a top view of the additive manufacturing system of FIG. 6A including a formed part.

FIG. 6E shows a perspective view of the formed part of FIG. 6D.

FIG. 7 shows a laser array of an additive manufacturing system.

FIG. 8 shows a bottom view of a laser array of an additive manufacturing system.

FIG. 9 shows a top view of a laser array of an additive manufacturing system at a stage of an additive manufacturing process.

FIG. 10 shows a top view of an additive manufacturing system.

FIG. 11 shows a top view of an additive manufacturing system.

FIG. 12 shows a top view of sintering pattern of an additive manufacturing process.

FIG. 13 shows a top view of an additive manufacturing system.

FIG. 14 shows a process flow diagram of a method for forming a part.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

Additive manufacturing processes are increasingly used in the formation of specialized parts. One such additive manufacturing process is selective laser melting (SLM), also known as direct metal laser melting (DMLM). SLM is a 3D printing technique which uses a high power-density laser to melt, sinter, or fuse the particles of metal powders together. However, conventional implementations of this method can include limitations with regard to production rate and such conventional techniques may not be a viable option for manufacturers who require large volumes of parts. It will be understood that while SLM or DMLM may be directly referenced herein, the methods and systems described herein can be implemented in additive manufacturing processes other than SLM or DMLM.

In some examples, a part, such as a metallic or ceramic housing for an electronic device, can be formed using an additive manufacturing process which includes scanning multiple laser spots onto metallic or ceramic powder. The laser spots can be generated by multiple lasers that make up a laser array. The laser array can include multiple rows of laser heads. In some examples, the laser array can include at least 10, 25, 50, or 100 lasers or more. The laser array can include a variety of lasers that can operate at multiple resolutions and wavelengths to form different laser spot sizes on the powder bed. In some examples, a single laser of a laser array can generate a laser spot having a spot size of about 20 microns to about 200 microns. The lasers making up the laser array can operate at a collective output power of about 50 kilowatts to about 500 kilowatts. In some examples, the individual lasers of the array can have a power of between about 5 watts and about 1000 watts, or more. In some examples, and as described herein, the laser array can include lasers having multiple different output powers and/or multiple different spot sizes.

In some examples, the laser array can move relative to the powder bed. It will be understood that the description of the laser array moving relative to the powder bed can include configurations where the powder bed may move relative to the laser array while the laser array remains stationary, or configurations where the powder bed and laser array both move relative to each other. The laser array can include a reflecting element, such as a galvo mirror to direct radiation generated by the laser array, for example in the form of laser beams, to desired locations on the powder bed. Further, the system can include a fiber optics to accurately place the laser spots at a desired location on the powder bed. In some examples, the reflective element and/or fiber optics can move or articulate to scan the laser spots across the powder bed. In some examples, the reflective element or elements, and/or fiber optics may control the location and movement of the laser spots while the laser array and/or powder bed remain stationary.

In some examples, scanning the laser spots across the powder bed can include moving the laser spots in a direction parallel to a common plane of the laser spots. The lasers can be operationally coupled to a controller which can activate or turn off any of the lasers as desired. The decisions of whether to turn a particular laser on or off can be based on a targeted geometry of the part being formed. For instance, dependent on the shape and geometry of the part that is being formed, the controller can signal the laser to turn on or off depending on where that particular laser is located within the array and where the array is positioned relative to the powder bed. Activation of a laser can also depend on a depth or thickness of the part. When the laser array is activated, laser spots can be formed on the desired location within the powder bed to selectively sinter the powder contained in the powder bed. By sintering or forming melt pools at select locations, and allowing the pools to solidify the part can be formed. Further, by having the capability to simultaneously activate several lasers across the array, multiple melt pools can be formed concurrently which reduced formation time of the part.

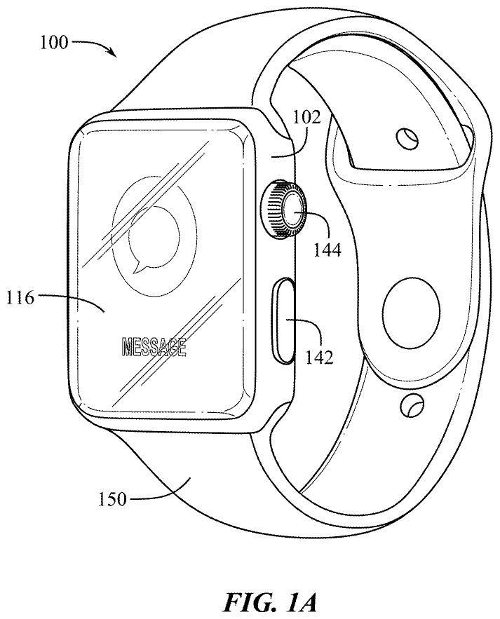

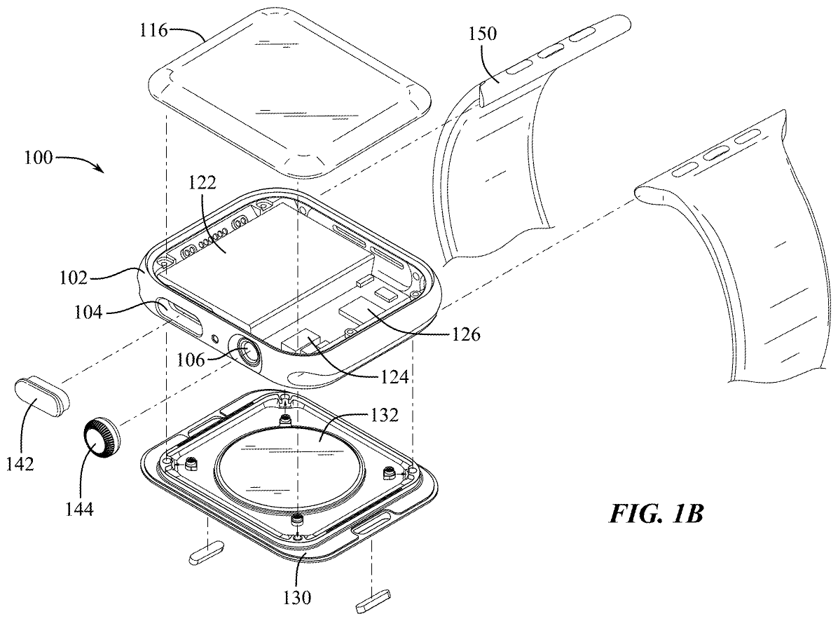

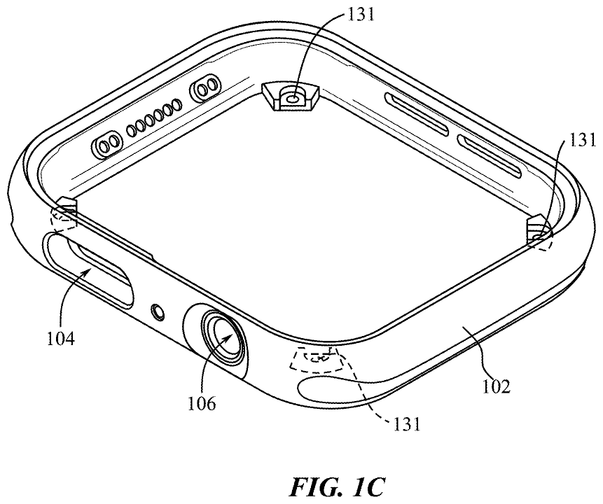

These and other embodiments are discussed below with reference to FIGS. 1-14. However, those skilled in the art will readily appreciate that the detailed description given herein with respect to these Figures is for explanatory purposes only and should not be construed as limiting.

FIG. 1A shows an example of an electronic device 100. The electronic device shown in FIG. 1 is a watch, such as a smartwatch. The smartwatch of FIG. 1 is merely one representative example of a device that can be used in conjunction with the components and methods disclosed herein. The electronic device 100 can correspond to any form of a wearable electronic device, a portable media player, a media storage device, a portable digital assistant (“PDA”), a tablet computer, a computer, a mobile communication device, a GPS unit, a remote control device, and the like. The electronic device 100 can be referred to as an electronic device, a device, or a consumer device. The electronic device 100 includes a main housing or enclosure 102. The housing or enclosure 102 can be connected to a front cover 116 and can have a strap 150 attached thereto. A number of input elements, such as a rotatable crown 144 and/or a button 142 can be attached to and can protrude from the housing 102. Further details of the electronic device 100 are provided below with reference to FIGS. 1B and 1C.

Referring now to FIG. 1B, the housing 102 can substantially define at least a portion of an exterior surface of the device 100. The cover 116 can include glass, plastic, or any other substantially transparent material, component, or assembly. The cover 116 can cover or otherwise overlay a display, a camera, a touch sensitive surface, such as a touchscreen, or other component of the device 100. The cover 116 can define a front exterior surface of the device 100. A back cover 130 can also be attached to the housing 102, for example, opposite the cover 116. The back cover 130 can include ceramic, plastic, metal, or combinations thereof. In some examples, the back cover 130 can include an electromagnetically transparent portion 132. The electromagnetically transparent portion 132 can be transparent to any wavelength of electromagnetic radiation, such as visual light, infrared light, radio waves, or combinations thereof. Together, the housing 102, the cover 116, and the back cover 130 can substantially define an interior volume and an exterior surface of the device 100. In some examples, the housing 102 defines at least a portion of the back cover 130, such that the back cover 130 and the housing 102 are integrally formed. The housing 102, the back cover 130, or any of the other components of the device 100 can be formed according to the additive manufacturing processes described herein. In some examples, the housing 102 can be formed from a metallic material. As discussed in greater detail below, the housing 102 can be formed using an additive manufacturing process, such as selective laser melting. In some examples, the housing 102 can also include a surface layer formed by a physical vapor deposition process.

The housing 102 can be a substantially continuous or unitary component, and can include one or more openings 104, 106 to receive components, such as components 142 and 144 of the electronic device 100, and/or to provide access to an internal portion of the electronic device 100. Additionally, other components of the electronic device 100 can be formed from, or can include, a metallic material formed using the methods and techniques described herein.

The electronic device 100 can further include a strap 150, or other component designed to attach the device 100 to a user, or to provide wearable functionality. In some examples, the strap 150 can be a flexible material that can comfortably allow the device 100 to be retained on a user's body at a desired location. Further, the housing 102 can include a feature or features that can provide attachment locations for the strap 150. In some examples, the strap 150 can be retained on the housing 102 by any desired techniques. For example, the strap 150 can include any combination of magnets that are attracted with magnets disposed within the housing 102, or the strap 150 can include retention components that mechanically retain the strap 150 against the housing 102.

The device 100 can also include internal components, such as a haptic engine 124, a battery 122, and a system in package (SiP), including one or more integrated circuits 126, such as processors, sensors, and memory. The SiP can also include a package. All or a portion of one or more internal components can be contained within the housing 102.

The internal components, such as one or more of components 122, 124, 126, can be disposed within an internal volume defined at least partially by the housing 102, and can be affixed to the housing 102 via internal surfaces, attachment features, threaded connectors, studs, posts, or other features that are formed into, defined by, or otherwise part of the housing 102 and/or the cover 116 or back cover 130. In some examples, the attachment features can be formed relatively easily on interior surfaces of the housing 102, for example, by machining. In some examples, the attachment features can be formed during the additive manufacturing process, as described herein.

The housing 102 formed from a metallic material can be conformable to interior dimensional requirements, as defined by the internal components 122, 124, 126. For example, the structure of the housing 102 can be defined or limited exclusively or primarily by the internal components the housing 102 is designed to accommodate. That is, the housing 102 can be shaped to house the interior components 122, 124, 126 in a dimensionally efficient manner without being constrained by factors other than the dimensions of the components, such as conventional manufacturing limitations.

Referring now to FIG. 1C, a perspective view of the housing 102 of the electronic device 100 is shown. The housing 102 can represent a 3D printed structure that is partially or entirely formed using the additive manufacturing processes described herein. The illustration of FIG. 1C can be representative of the shape and design of the structure immediately after printing, or can represent a finalized housing that has undergone additional processing, such as machining.

The housing 102 can also include features, such as such as speaker ports, button apertures, or charging port apertures. As shown, apertures 104, 106, can be integrally formed in the housing 102. In some examples, protruding features 131 can also be integrally formed in the housing 102 by the processes described herein. The features 131 can engage with fasteners when assembling the electronic device, while features 104 and 106 can be configured to receive buttons or inputs of the electronic device. As discussed in greater detail below, the housing 102 can be formed or machined to define the features.

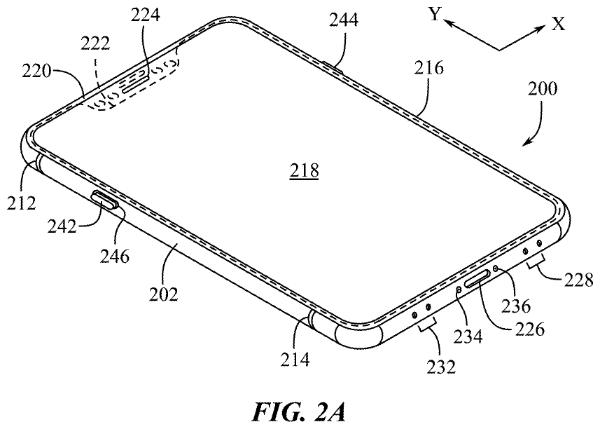

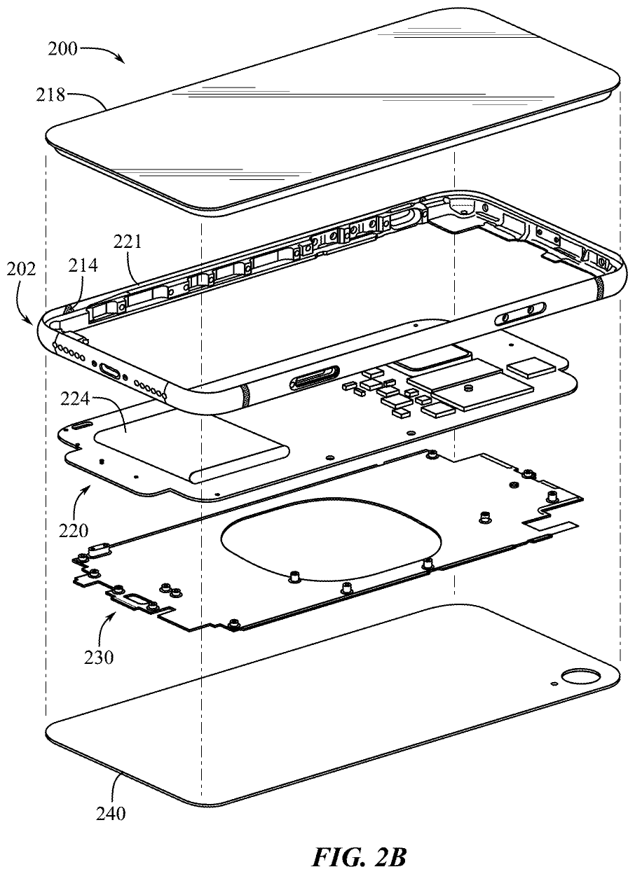

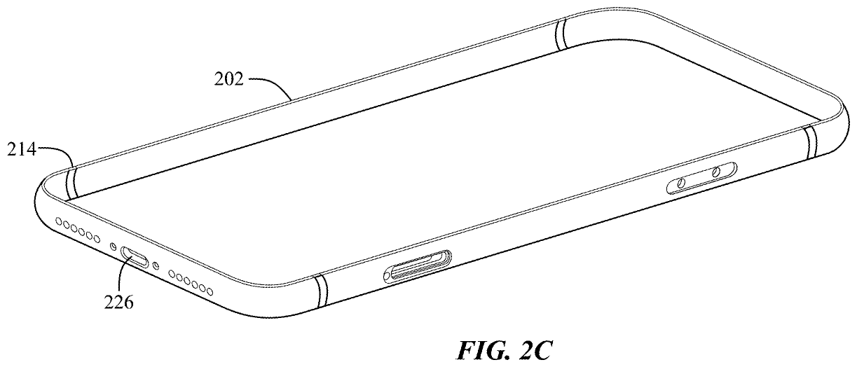

FIG. 2A illustrates a perspective view of an embodiment of an electronic device 200. The electronic device 200 shown in FIG. 2A is a mobile wireless communication device, such as a smartphone. The smartphone of FIG. 2A is merely one representative example of a device that can be used in conjunction with the systems and methods disclosed herein. Electronic device 200 can correspond to any form of wearable electronic device, a portable media player, a media storage device, a portable digital assistant (“PDA”), a tablet computer, a computer, a mobile communication device, a GPS unit, a remote control device, or other electronic device. The electronic device 200 can be referred to as an electronic device, a consumer device, or simply as a device.

The electronic device 200 can have a housing that includes a band or a frame 202 that defines an outer perimeter of the electronic device 200. The frame 202 can be formed using substantially similar methods used to form housing 102. The frame 202, or portions thereof, can be or include an additively manufactured, or printed metallic component, as described herein. In some examples, the frame 202 can define one or more sidewall components of the electronic device 200. In some examples, the frame 202 defines a non-continuous perimeter of the electronic device 200. That is, the frame 202 can be formed with gaps or spaces therein.

In some examples, the frame 202 includes an antenna assembly (not shown in FIG. 2A). As a result, a non-metal material, or materials, can separate the sidewall components of the frame 202 from each other in order to electrically isolate the sidewall components. For example, separating materials 212, 214 can be position between sections of the frame 202. The aforementioned materials can include an electrically inert, or insulating, material(s), such as plastics and/or resin, as non-limiting examples. As discussed in greater detail below, the separating materials 212, 214 can be formed using similar manufacturing techniques as the frame 202. For instance, the separating materials 212, 214 can be formed using an additive manufacturing process.

The electronic device 200 can further include a display assembly 216 (shown as a dotted line) that is covered by a protective cover 218. The display assembly 216 can include multiple layers, with each layer providing a unique function. The display assembly 216 can be partially covered by a border 220 that extends along an outer edge of the protective cover 218 and partially covers an outer edge of the display assembly 216. In some examples, the border 220 can be a portion of the frame 202, being formed along with the frame 202. The border 220 can be positioned to hide or obscure any electrical and mechanical connections between the layers of the display assembly 216 and flexible circuit connectors. Also, the border 220 can exhibit a uniform thickness. For example, the border 220 can include a thickness that generally does not change in the X- and Y-dimensions.

Also, as shown in FIG. 2A, the display assembly 216 can include a notch 222, representing an absence of the display assembly 216. The notch 222 can allow for a vision system that provides the electronic device 200 with information for object recognition, such as facial recognition. In this regard, the electronic device 200 can include a masking layer with openings (shown as dotted lines) designed to hide or obscure the vision system, while the openings allow the vision system to provide the object recognition information. Also, the protective cover 218 can be formed from a transparent material, such as glass, plastic, sapphire, or similar transparent materials. In this regard, the protective cover 218 can be referred to as a transparent cover, a transparent protective cover, or a cover glass (when the protective cover 218 includes glass). As shown in FIG. 2A, the protective cover 218 includes an opening 224, which can represent a single opening of the protective cover 218. The opening 224 can allow for transmission of acoustical energy (in the form of audible sound) into the electronic device 200, which can be received by a microphone (not shown in FIG. 2A) of the electronic device 200. Further, the opening 224 can allow for transmission of acoustical energy (in the form of audible sound) out of the electronic device 200, which can be generated by an audio module (not shown in FIG. 2A) of the electronic device 200.

In some examples, the frame 202 can define a port 226 designed to receive a connector of a cable assembly. The port 226 allows the electronic device 200 to communication data information (send and receive), and also allows the electronic device 200 to receive electrical energy to charge a battery assembly. Accordingly, the port 226 can include terminals that electrically couple to the connector. The port 226 can be formed as part of the additive manufacturing process to form the frame 202 or can be formed by subsequent processing.

Furthermore, the frame 202 can define several openings. For example, the frame 202 can define openings 228 that allow an additional audio module (not shown in FIG. 2A) of the electronic device to emit acoustical energy out of the electronic device 200. The frame 202 can further define openings 232 that allow a microphone of the electronic device to receive acoustical energy. The frame 202 can define holes to receive fasteners. For instance, the electronic device 200 can also include a first fastener 234 and a second fastener 236 designed to be fastened to a rail that is coupled to the protective cover 218. In this way, the first fastener 234 and the second fastener 236 can be designed to couple the protective cover 218 with the frame 202. These various openings can be formed as part of a 3D printing process in conjunction with formation of the frame 202. In some examples, the openings are machined into the frame 202 after the frame 202 has been printed.

The electronic device 200 can include several control inputs designed to provide a command to the electronic device 200. For example, the electronic device 200 can include a first control input 242 and a second control input 244. The aforementioned control inputs can be used to adjust the visual information presented on the display assembly 216, and/or the volume of acoustical energy output by an audio module, as non-limiting examples. The controls can include one of a switch, a sensor, or a button designed to generate a command to a processor circuit. The control inputs can at least partially extend through openings in the sidewall components. For example, the second sidewall component 206 can include an opening 246 that receives the first control input 242. Further details of the electronic device 200 are provided below with reference to FIG. 2B.

FIG. 2B illustrates an exploded view of the electronic device 200. As shown, the frame 202 at least partially defines an exterior portion, such as an outer perimeter of the electronic device. The frame 202, can include one or more features to receive or couple to other components of the device 200, such as feature 221. For example, the band 202 can include any number of features such as apertures, cavities, indentations, bosses, protrusions, and other mating features configured to receive and/or attach to one or more components of the device 200. In some examples, the feature 221 can be printed onto the frame 202 by an additive manufacturing process, as described herein. Further, in some examples, the feature 221 can include a metallic material different than the metallic material of the frame 202. In some examples, both the frame 202 and the feature 221 can be formed by one or more additive manufacturing processes, as described herein.

The electronic device 200 can include internal components such as processors, memory, circuit boards, batteries, and sensors. Such components can be disposed within an internal volume defined, at least partially, by the frame 202, and can be affixed to the frame 202, via internal surfaces, attachment features such as feature 221, threaded connectors, studs, posts, and/or other fixing features, that are formed into, defined by, or otherwise part of the frame 202.

The device 200 can include internal components, such as a system in package (SiP), including one or more integrated circuits such as a processors, sensors, and memory. The device 200 can also include a battery 224 housed in the internal volume of the device 200. The device 200 can also include one or more sensors, such as optical or other sensors, that can sense or otherwise detect information regarding the environment exterior to the internal volume of the device 200. Additional components, such as a haptic engine, can also be included in the device 200. In some examples, the display assembly can be received by and/or attached to the frame 202 by one or more attachment features.

The electronic device 200 can further include a chassis 220 that can provide structural support. The chassis 220 can include a rigid material, such as a metal, or can include a composite construction. The chassis 220 can also be coupled to the frame 202. In this manner, the chassis 220 can provide an electrical grounding path for components electrically coupled to the chassis. The electronic device can alternatively or additionally include a back plate 230 having cladding layers and/or other attachment features such that one or more components of the electronic device 200 can be attached to the back plate 230, for example, via welding. The back plate 230 can form conductive pathways for connecting components of the electronic device 200. In some examples, the back plate 230 can be attached to the frame 202 of the device 200 by one or more attachment features. In some examples, the frame 202, the chassis 220, and the back plate 230 can be integrally formed with one another in any combination as a sectioned element by the additive manufacturing processes described herein.

An exterior surface of the electronic device 200 can further be defined by a back cover 240 that can be coupled with the frame 202. In this regard, the back cover 240 can combine with the frame 202 to form an enclosure or a housing of the electronic device 200, with the enclosure or housing (including frame 202 and back cover 240) at least partially defining an internal volume. The back cover 240 can include a transparent material, such as glass, plastic, sapphire, or another transparent material. As discussed below, the back cover 240 can be formed together with the frame 202 using an additive manufacturing process.

The housing, including the frame 202, can be conformable to interior dimensional requirements, as defined by the internal components. For example, the structure of the housing including a frame 202 can be defined or limited exclusively or primarily by the internal components the housing is designed to accommodate. That is, because a housing including a frame 202 can be extremely light and strong, the housing can be shaped to house the interior components in a dimensionally efficient manner without being constrained by factors other than the dimensions of the components, such as the need for additional structural elements. In some examples, these formation processes discussed herein can allow for the housing and/or frame 202 to have a detailed shape or design that is tailored specifically to satisfy one or more needs, such as internal dimensional requirements, without the need for additional features to reinforce the structure of the housing. Additionally, artifacts of the manufacturing process of the housing can be eliminated. Furthermore, other components of the electronic device 200, such as individual internal structural components like the chassis 220 or exterior input components, can be formed using the manufacturing techniques described herein.

FIG. 2C shows a perspective view of the frame 202 of a housing or enclosure of electronic device 200, for example, electronic device 200 described with respect to FIGS. 2A and 2B. The frame 202 can represent a 3D printed structure that is partially or entirely formed using the additive manufacturing processes described herein. The illustration of FIG. 2C can be representative of the shape and design of the structure immediately after printing or can represent a finalized housing that has underdone additional subtractive machining.

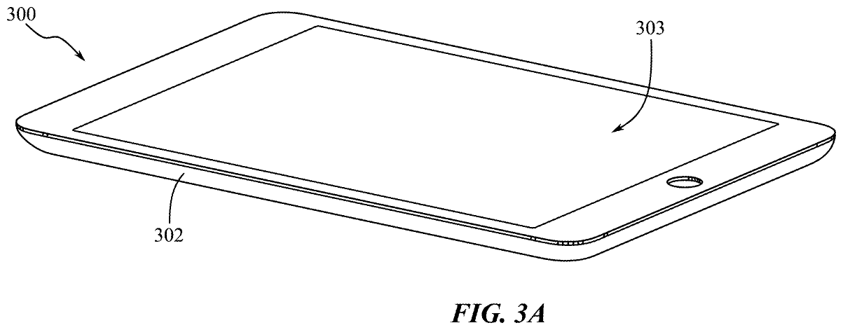

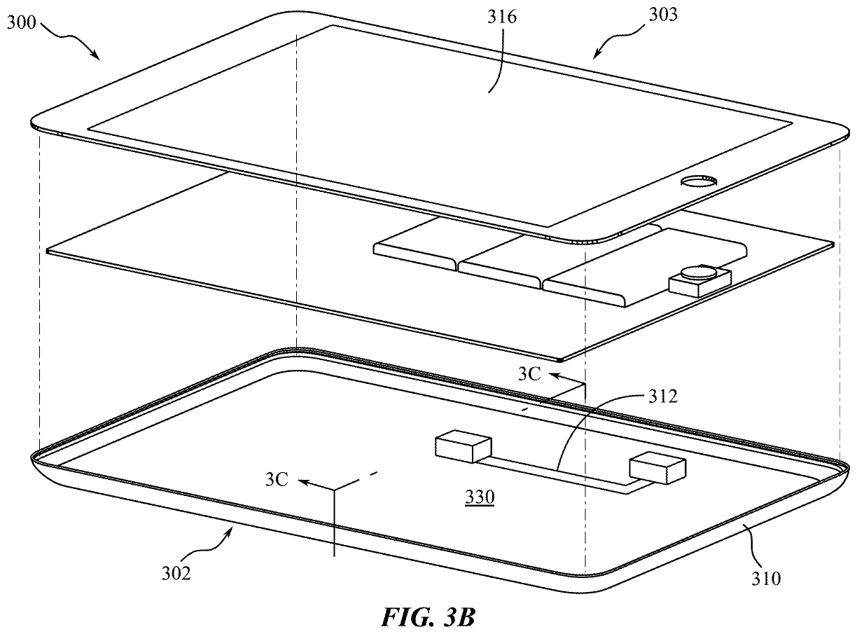

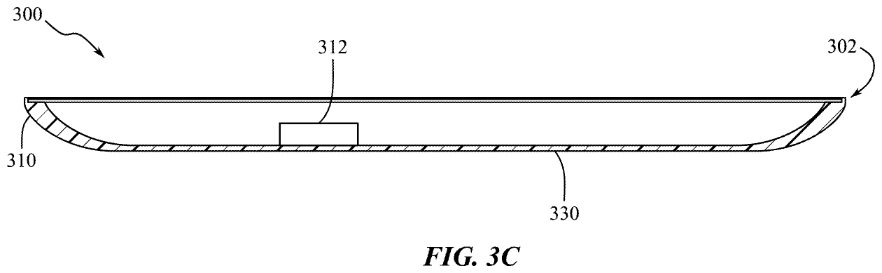

In some examples, the frame 202 can have multiple composite sidewall components that are joined together. In some examples, the housing or enclosure for the electronic device 200 can include or can be formed from a single component having an interior portion including a first material, and exterior portion including a second, different material, as described herein. Further, in some examples, the components can form portions of the housing or enclosure other than the sidewalls, such as a top portion, a bottom portion, or any portion of the housing or enclosure. The frame 202 can include or can be formed from a metallic material, such as aluminum, titanium, stainless steel, or combinations thereof. For example, the frame 202 can include a stainless steel alloy, for example, a 316L stainless steel alloy. The frame 202 can also include a surface coating, such as a coating deposited by a physical vapor deposition process. Further details of electronic devices including components formed according to the processes described herein are described with respect to FIGS. 3A-3C.

As shown in FIG. 3A, the present processes can also be used in the formation of a housing 302 for a tablet computer 300. As shown, the tablet computer 300 includes a front transparent cover 303 and a housing 302. The housing or enclosure 302 can be defined by a metallic and/or ceramic components formed using additive manufacturing processes, as described herein.

The tablet computer of FIG. 3A is merely one representative example of a device that can be used in conjunction with the systems and methods disclosed herein. Electronic device 300 can correspond to any form of portable electronic device, a portable media player, a media storage device, a portable digital assistant (“PDA”), a tablet computer, a computer, a mobile communication device, a GPS unit, a remote control device, or other electronic device. The electronic device 300 can be referred to as an electronic device, a consumer device, or simply as a device.

As shown in FIG. 3B, the electronic device 300 can have a housing 302 that includes a back plate 330 and a beveled edge or sidewall 310. The housing 302 can be formed using substantially similar methods used to form housing 102 and 202. The housing 302, or portions thereof, can be or can include a composite component including multiple different materials, as described herein. In some examples, the housing 302 can define one or more sidewall components 310 extending from the back plate 330. In some examples, the housing 302 defines a continuous or non-continuous perimeter of the electronic device 300. That is, in one example, the housing 302 can be formed with gaps or spaces therein.

In some examples, various features 312 can be printed onto the back plate 330. For example, the features 312 can include attachment features that are printed onto the back plate 330 to attach one or more components of the device 300 to the back plate 330. In some examples, the features 312 can include thermal/electrical pathways that are printed on the back plate 330 and are configured to operatively communicate with various components of the device 300. In some examples, the feature 312 can include ribs or other structural features. In some examples, the features 312 can be printed or can be formed onto an existing back plate 330, for example, by an additive manufacturing process, as described herein. In some examples, the back plate 330 can include a first metal and the features 312 can include the same metal, a second, different metal, or combinations thereof. In some examples, the first metal can include aluminum and the second metal can include steel, titanium, aluminum, or an alloy thereof. In some examples, however, the features 312 can be integrally formed with the back plate 330, for example, as part of a single additive manufacturing process, as described herein.

The electronic device 300 can further include a display assembly 316. The display assembly 316 can include multiple layers, with each layer providing a unique function. The display assembly 316 can include a protective cover formed from a transparent material, such as glass, plastic, sapphire, or similar transparent materials. In this regard, the protective cover can be referred to as a transparent cover, a transparent protective cover, or a cover glass. Also, the electronic device 300 can include, according to some examples, a button, such as “home button,” commonly found in electronic devices.

In some examples, the housing 302 can define a port (not shown) designed to receive a connector of a cable assembly. The port can allow the electronic device 300 to communicate data information (send and receive), and also allows the electronic device 300 to receive electrical energy to charge a battery assembly. The port can be formed as part of the additive manufacturing process used to form the housing 302, or the port can be formed by subsequent subtractive manufacturing methods. Furthermore, the housing 302 can define several openings. For example, the housing 302 can define openings (not shown) that allow an additional audio module of the electronic device to emit acoustical energy out of the electronic device 300. The housing 302 can further define openings that allow a microphone of the electronic device to receive acoustical energy. The housing 302 can define holes to receive fasteners. These various openings can be formed as part of a 3D printing process in conjunction with formation of the housing 302. In some examples, the openings are machined into the housing 302 after it has been printed.

The housing 302 can include any number of features such as apertures, cavities, indentations, bosses, protrusions, and other mating features. The electronic device 300 can include internal components such as processors, memory, circuit boards, batteries, and sensors. Such components can be disposed within an internal volume defined, at least partially, by the housing 302, and can be affixed to the housing 302, via internal surfaces, attachment features, threaded connectors, studs, posts, and/or other fixing features, that are formed into, defined by, or otherwise part of the housing 302.

The housing 302 can include or be formed from one or more metallic materials, such as aluminum, titanium, stainless steel, or combinations thereof. For example, the housing 302 can include a stainless steel alloy, for example, a 316L stainless steel alloy. The housing 302 can also include a surface coating, such as a coating deposited by a physical vapor deposition process, as described herein.

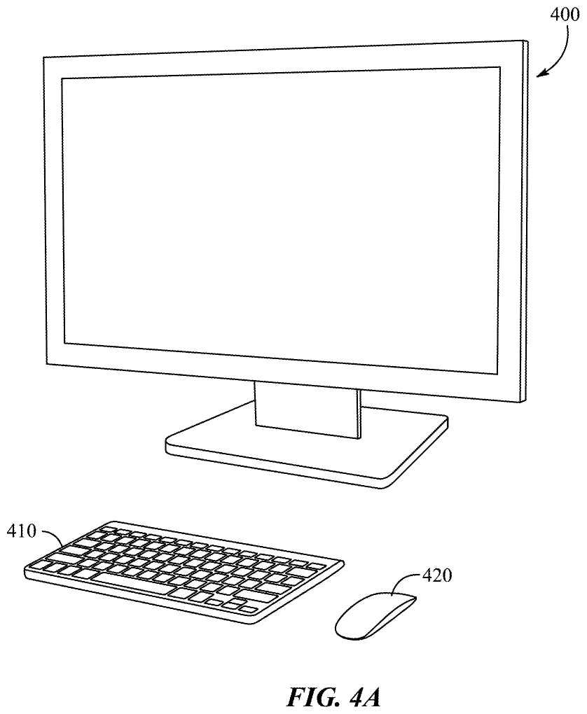

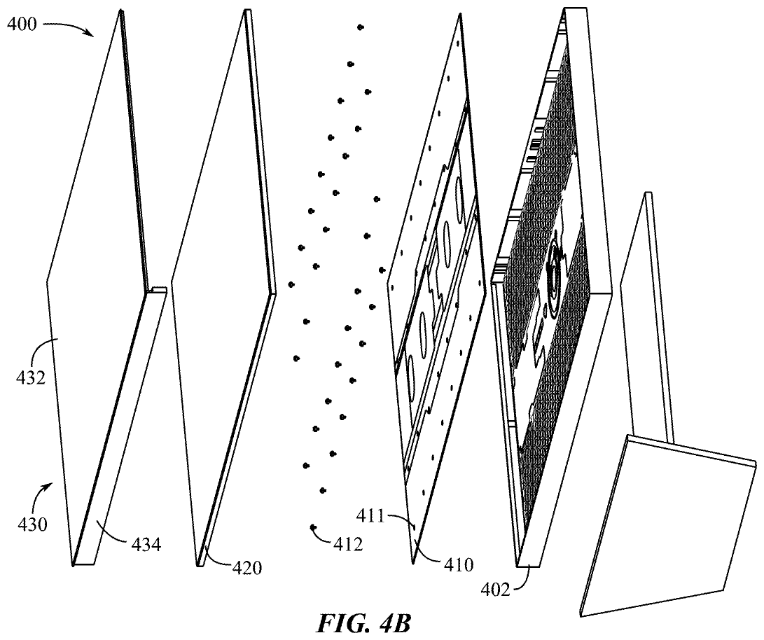

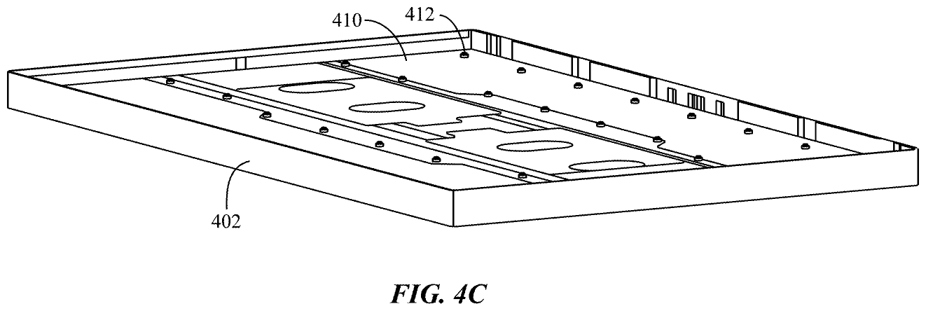

FIG. 3C shows a cross-sectional view of the housing 302. As shown, the housing 302 can be formed from a single unitary piece of material, such as a single sectioned element, as described herein. The housing 302 can represent a 3D metal printed structure that is partially or entirely formed using the additive manufacturing processes described herein. The illustration of FIG. 3C can be representative of the shape and design of the structure immediately after printing, or can represent a finalized housing that has underdone additional subtractive machining. In some examples, the housing 302 can include multiple metallic materials that are formed together, as described herein. In some examples, the housing or enclosure for the electronic device 300 can include or can be formed form a single composite component having an interior and an exterior portion, as described herein. Further details of electronic devices including components formed according to the processes described herein are described below with respect to FIGS. 4A-4C.

FIG. 4A shows an example electronic device 400 that can include a structural housing formed using additive manufacturing techniques, as detailed herein. The electronic device 400 shown in FIG. 4A is a display or monitor, for example, as can be used with a computer. This is, however, merely one representative example of a device that can be used in conjunction with the ideas disclosed herein. The electronic device 400 can, for example, correspond to a portable media player, a media storage device, a portable digital assistant (“PDA”), a tablet computer, a computer, a mobile communication device, a GPS unit, a remote-control device, or other electronic devices. The electronic device 400 can be referred to as an electronic device, a device, or a consumer device. As shown, the electronic device 400 can include any number of input devices such as a keyboard 410, a mouse 420, a track pad, a stylus, a microphone, or any combination of input devices. Further details of the electronic device 400 are provided below with reference to FIGS. 4B-4C.

Referring now to FIG. 4B, the electronic device 400 can include a housing 402 at least partially defining an exterior surface and an internal volume of the device. In some examples, the housing can include a portion or a region that can include a body defining a first surface and a second surface. At least a portion of the body can include a three-dimensional pattern or matrix of apertures or passageways as described herein. In some examples, however, the housing 402 may not define any patterns or through-holes therein. The electronic device 400 can further include a back plate 410 that can be disposed adjacent to a major surface of the housing 402 at least partially defining the internal volume. The back plate 410 can be formed separately from the housing 402 or the back plate 410 can be formed together with the housing 402 to form a single unitary enclosure. In some examples, such as where the housing 402 includes a matrix of passageways, the back plate 410 can serve to seal the internal volume from an exterior or ambient environment that might otherwise be accessible through the passageways. In some examples, this seal can be substantially watertight or airtight and can prevent or significantly inhibit the passage of dust or other particulate matter from the ambient environment into the internal cavity of the device 400.

The back plate 410 can define one or more apertures 411 that can be sized to receive a portion of an engagement feature 412, for example, a post of an engagement feature 412, as described herein. In some examples, the engagement feature or features 412 can secure the back plate 410 to the housing 402 and can further seal the back plate 410 and the housing 402 at the location of the apertures 411. Although referred to separately as a housing 402 and a back plate 410, in some examples, the housing 402 and the back plate 410 are referred to together as a housing or enclosure.

The electronic device 400 can further include a display component 420, for example, a backlight unit 420. Although illustrated as a backlight unit, the display component 420 can include substantially any desired display or device component. In some examples, the backlight unit 420 can include internal components, such as one or more light emitting diodes (LEDs), cavity reflectors associated with the LEDs, internal posts that can define a thickness of the backlight unit, printed circuit boards, and a baseplate. A portion of the backlight unit 420, such as a rear major surface thereof, can define one or more retention features (not shown) that correspond to and can slidably engage with the engagement features 412 protruding from the back plate 410.

The electronic device 400 can also include a cover assembly 430. The cover assembly 430 can include a cover 432, which can at least partially define an exterior surface of the device 400. The cover can be any desired transparent material, for example, glass, plastic, sapphire, or other transparent materials. In some examples, a display unit can be adhered to the cover 432, for example, to a surface of the cover 432 opposite the surface defining an exterior surface of the device 400. In some examples, the display unit can be an LCD unit, although in other examples any desired form of display unit can be used, such as an LED display unit, OLED display unit, plasma display unit, quantum dot display unit, and other display units. The display unit can be affixed to the cover by gluing, adhering, or any other desired securing technique. Further, in some examples, the cover 432 can cover additional components such as a camera, or a touch sensitive surface such as a touchscreen.

The cover assembly 430 can further include a display component 434 extending from the cover 432. In some examples, the display component 434 can include one or more electronic components, such as printed circuit boards including processors, memory, and other electrical components, and can be referred to as daughterboards. The daughterboards 434 can be electrically connected to the display unit, for example, by a flexible electrical connector, and can drive or control the display unit. The daughterboards 434 can extend substantially perpendicularly from the cover 432, and can be mounted or affixed to the cover 432. In some examples, a bracket can be glued or otherwise affixed to the same side of the cover 432 as the display unit to maintain the daughterboards 434 in a position perpendicular to the cover 432. In some examples, the bracket can include metal, such as stainless steel. Additional electrical connectors (not shown), such as flexible electrical connectors, can extend from the daughterboards 434.

In an assembled state, the daughterboards 434 can be disposed in the internal volume in a space between the backlight unit 420 and a sidewall of the housing 402. The cover 432 can be fastened to the housing 402, for example, along a periphery thereof by a reworkable adhesive that can be provided through a gap between the exterior surface of the housing 402 and the cover 432. Any number of additional internal components can be disposed between the housing 402 and the cover assembly 430. The housing 402 can define at least a portion of an exterior surface of the device 400. The cover 432 can define a front exterior surface of the device 400. Together, the housing 402 and the cover 432 can substantially define the exterior surface and/or the internal volume of the device 400.

The device 400 can also include internal components such as processors, memory, circuit boards, batteries, fans, sensors, and other electronic components. Such components can be disposed within the internal volume defined at least partially by the housing 402 and the cover 432, and can be affixed to the housing 402 via internal surfaces, attachment features, threaded connectors, studs, or posts that are formed into, defined by, or otherwise part of the housing 402 and/or the cover assembly 430.

FIG. 4C shows a perspective view of the housing 402 including the back plate 410 affixed thereto, and one or more engagement features 412 passing through the back plate 410 and into the housing 402. The housing 402 can represent a 3D printed structure that is partially or entirely formed using the additive manufacturing processes described herein. The illustration of FIG. 4C can be representative of the shape and design of the structure immediately after printing, or can represent a finalized housing that has underdone additional subtractive machining.

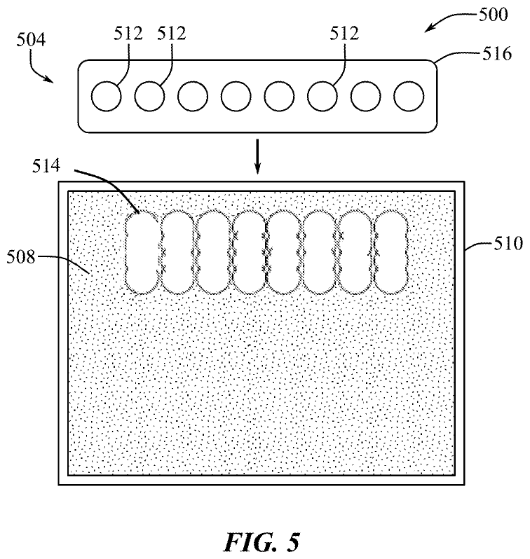

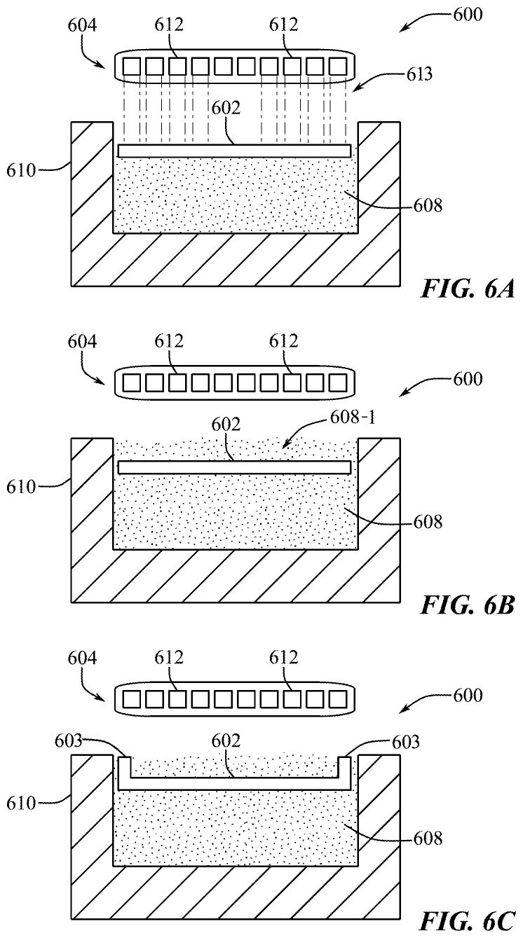

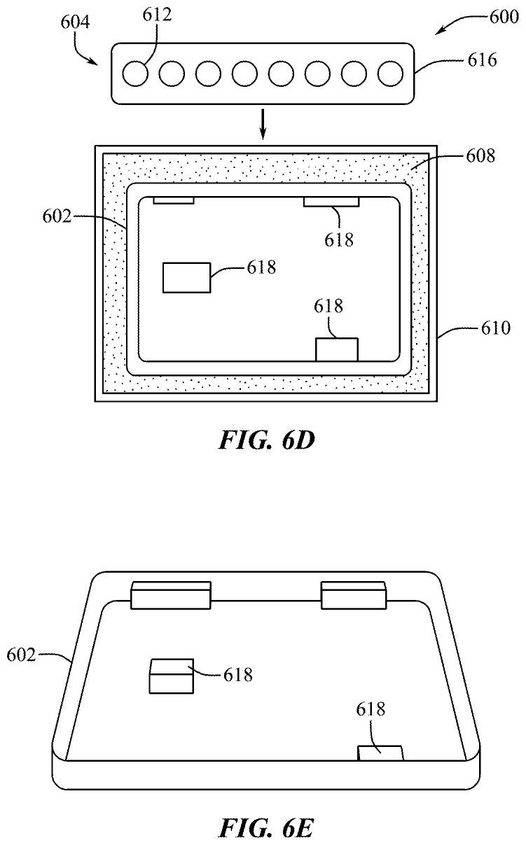

While any number or variety of components of an electronic device, for example, any of electronic devices 100, 200, 300, and 400 can be formed using additive manufacturing processes, the housing of an electronic device can be, for example, formed by separating a section from an elongated body formed using direct metal deposition, as described herein. The structure, methods, and materials used in the formation of electronic device housings, as well as the formation of any features on those housings, can apply not only to the specific examples discussed herein, but to any number or variety of embodiments in any combination. Various embodiments of 3D printed structures are described below with reference to FIGS. 5-6D.

FIG. 5 illustrates a top view of an SLM apparatus or system 500. The SLM apparatus 500 can include a laser array 504 and a powder bed 510. The laser array 504 can be positioned above the powder bed 510. The laser array 504 can include a housing 516 configured to contain a plurality of lasers 512. The lasers 512 can be configured to direct electromagnetic radiation, for example in the form of one or more laser beams, toward powder 508 contained in the powder bed 510. The laser array 504 can include between about 10 to 1,000 lasers 512, about 25 to 1,000 lasers 512, about 50 to 1,000 lasers 512, or about 100 to about 1,000 lasers 512. In some examples, the laser array 504 can contain between 1,000 and 10,000 lasers 512, or more. The number of lasers 512 can depend on a variety of factors, such as the size of the powder bed 510, the size of the part being formed, the particle or grain size of the powder 508, and the resolution of the lasers 512. The lasers 512 can be any radiation or heat source capable of fusing the powder 508, including fiber lasers or other energy transmitters such as high powered electron guns. The laser array 504 can include multiple reflective elements (not shown), such as mirrors, and/or multiple fiber optics (not shown) to direct the radiation from the lasers 512 to the powder bed 510.

In some examples, the lasers 512 are positioned adjacent one another in a common plane. The lasers 512 can positioned and/or oriented to substantially span a width of the powder bed 510. In some examples, the lasers 512 are positioned or oriented to substantially span a width of a part being formed. The laser array 504 can be configured to translate or move relative to the powder bed 510. In some examples, the laser array 504 can remain stationary while the powder bed 510 moves relative to the laser array 504 to allow the lasers 512 to scan the powder bed. 510. For example, the laser array 504 can move over a footprint or projection of the powder bed, such that the radiation from the lasers 512 can span substantially all of the powder bed 510. In some examples, the laser array 504 can be configured to span a specific region of the powder bed that is configured to contain a formed part. As illustrated in FIG. 5, the laser array 504 can direct radiation to form laser spots 514 which sinter the powder 508 to form portions of a part.

The powder 508 in the powder bed 510 can include metallic and/or ceramic materials, such as one or more of steel, nickel, titanium, aluminum, cobalt-chromium, gold, platinum, silver, or ceramic. The powder 508 can include a variety of particle sizes and/or grain sizes depending on the part being formed and the specifications of the lasers 512 in the laser array 504. In some examples, the powder can include particles including a single grain, and thus the particle size and grain size can be substantially similar. In some examples, however, the powder can include particles including multiple grains. In some examples, the powder 508 can include particles having an average size, that is, an average major dimension or diameter, of between 10 microns and 200 microns. In some examples, the powder 508 can include particles having an average grain size of between 1 micron and 200 microns, or even between about 1 micron and 10 mm, or more. Further details of example stages of an SLM process as described herein are discussed below with reference to FIGS. 6A-6E.

FIG. 6A illustrates a cross sectional side view of an SLM apparatus 600 according to one embodiment. In certain aspects, the SLM apparatus 600 can be substantially similar to, and can include some or all of the features of the SLM apparatuses described herein, such as the SLM apparatus 500, discussed above. The SLM apparatus 600 can include a laser array 604 that is positioned above powder 608 in a powder bed 610. Individual lasers 612 of the laser array 604 can be configured to direct radiation 613 (illustrated in dashed lines) onto the powder 608 to form laser spots which sinter the powder to form a portion of a part 602. As illustrated, certain lasers 612 can be activated while others are not. It will be understood that because a width of the laser array 604 can be equal to or greater than a width of the part 602, and because the laser array 604 can move relative to the powder bed 610, for example, in a direction that is parallel to a common plane of the lasers 612, that at least a portion of the part 602 can be formed by a single unidirectional pass of the laser array 604 over the powder bed 610. In some examples, the laser array 604 can perform several back and forth trips over the powder bed 610 to form at least a portion of the part 602.

FIG. 6B illustrates the SLM apparatus 600 after a portion the part 602 has been sintered and additional powder 608-1 has been applied on top of the formed part 602. In some examples, only a portion of the part 602 is formed after an initial pass of the laser array 604, and additional sintering is required to form the complete part 602. After initial sintering of part 602 is complete, additional powder 608-1 can be added to the powder bed 610 such that the sintered part 602 is covered by powder 608-1.

FIG. 6C illustrates another stage of formation of the part 602. The laser array 604 can again pass over the powder bed 610 to sinter the added powder 608 which forms additional portions 603 of the part 602. The process can repeat several times as desired until the part 602 is complete.

FIG. 6D illustrates a top view of the SLM apparatus or system 600 with a complete part 602 having been formed in the powder bed 610. Although referred to as completed, in some examples additional processes can be performed on the part 602 subsequent to its formation by the SLM apparatus 600, such as additional subtractive and/or additive processes, or any other process as desired. As shown, the part 602 can include several features 618 formed during the SLM process. Further details regarding the component 602 and features 618 are discussed with reference to FIG. 6E.

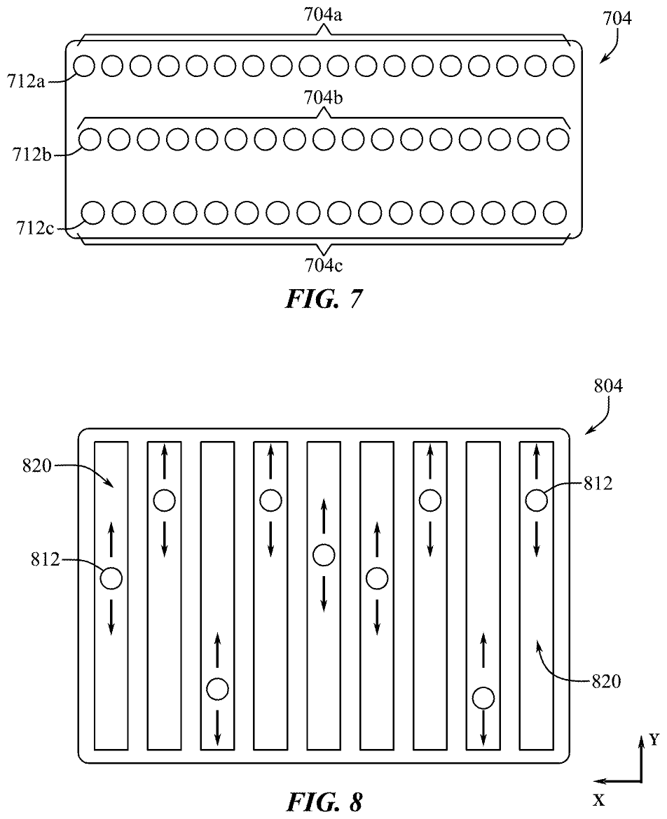

FIG. 6E illustrates a perspective view of the complete part 602. The part 602 can include several features 618. These features 618 can be formed using the SLM techniques as described herein. The features 618 can be formed from the same or different material than the part 602. In some examples, the features 618 are machined into the part 602 after the SLM process is complete. In some examples, the methods and techniques described herein can achieve extremely high deposition rates as compared to conventional 3D printing processes. For example, the methods described herein can have a deposition rate of greater than about 100 cm³/hour, greater than about 250 cm³/hour, greater than about 500 cm³/hour, greater than about 1000 cm³/hour, greater than about 5,000 cm³/hour, greater than about 10,000 cm³/hour, greater than about 25,000 cm³/hour, greater than about 50,000 cm³/hour, greater than about 100,000 cm³/hour, greater than about 500,000 cm³/hour, or even more. Further details of laser arrays are discussed below with reference to FIGS. 7 and 8.

FIG. 7 illustrates a laser array 704. In certain aspects, the laser array 704 can be substantially similar to, and can include some or all of the features of the laser arrays described herein, such as the laser arrays 504 and 604, discussed above. In some examples, the laser array 704 includes a multiples rows or columns lasers. As illustrated, the laser array 704 includes a first row 704a of lasers 712a, a second row 704b of lasers 712b, and a third row 704c of lasers 712c. Although illustrated as having a specific number of lasers, it should be understood that the laser arrays described herein, including any of the rows 704a, 704b, 704c, can have any number of lasers as desired, for example between 30 and 1000 lasers. In some examples, the lasers 712a within row 704a can be identical in terms of operating parameters. Likewise, the lasers 712b in row 704b and the lasers 712c in row 704c can be substantially identical to the adjacent lasers in their respective rows. In some examples, lasers within a row can vary in terms of operating capabilities. For example, lasers 712a in row 704a can include varying resolutions.

In some examples, the rows 704a, 704b, 704c can include lasers 712 of varying resolutions. For example, row 704a can include lasers 712a with a relatively small resolutions. Row 704b can include lasers 712b with resolutions that are larger than the resolutions of lasers 712a. Row 704c can include lasers 712c with resolutions that are larger than the resolutions of lasers 712b. In this manner, the multi-row laser array 704 can form parts from a variety of spot sizes and powder grain sizes. In some examples, the rows 704a, 704b, and 704c are contained within a single housing. In some examples, the rows 704a, 704b, and 704c are each contained within individual housings. Further, in some examples, the lasers 712a, 712b of rows 704a, 704b are not contained within a housing but can be positioned in a common plane with adjacent lasers of the respective rows. The multi-row laser array 704 can repeatedly form multiple laser spots on a powder bed, thereby allowing fewer passes of the laser array to complete the part. Further examples of laser arrays are discussed below with reference to FIG. 8.

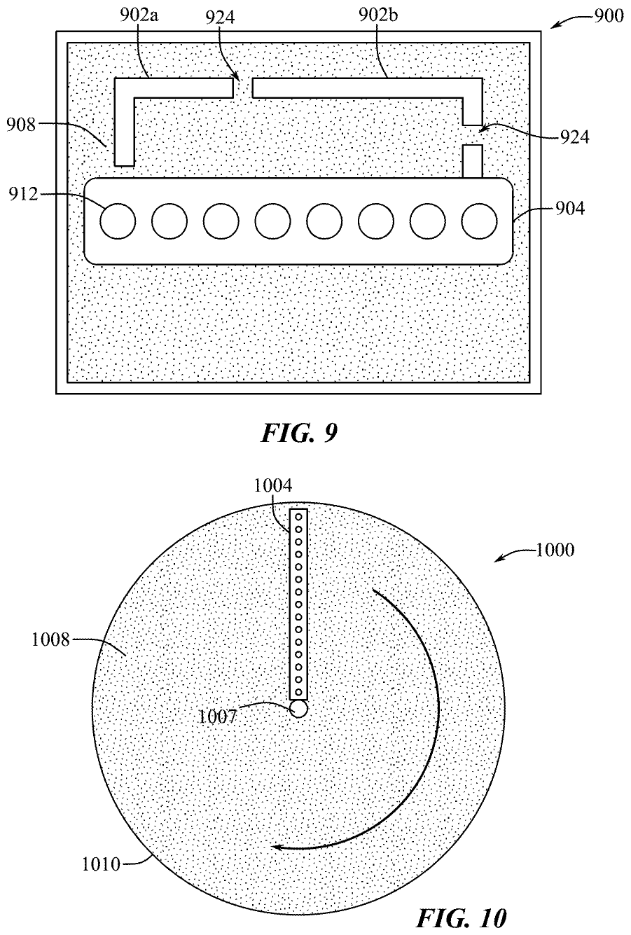

FIG. 8 illustrates a bottom view of a laser array 804. In certain aspects, the laser array 804 can be substantially similar to, and can include some or all of the features of the laser arrays described herein, such as the laser array 704, discussed above. The laser array 804 can include multiple lasers 812 as described herein. The lasers 812 can move independently from one another. In some examples, the lasers 812 can move in tracks 820 that are parallel to adjacent tracks 820. The lasers 812 can translate back and forth within their respective tracks 820 independently as desired. The lasers 812 can be otherwise fixed along the axis perpendicular to the tracks 820. By allowing independent motion of each laser 812, the laser array 804 can more efficiently form parts in fewer passes. The laser array 804 can also be more time efficient by allowing sintering of multiple independent melt pools that may be at different “height” positions within the powder bed. In other words, the laser array 804 can be positioned over a powder bed and can simultaneously sinters at multiple separate locations. The individually formed melt pools can be located at different location along the x-axis and also at different location along the y-axis. This simultaneous formation of melt pools at different x-axis location and y-axis locations can reduce formation time of the part. Further details of SLM apparatuses are discussed below with reference to FIG. 9.

FIG. 9 illustrates top view of an SLM apparatus 900. In certain aspects, the SLM apparatus 900 can be substantially similar to, and can include some or all of the features of the SLM apparatuses described herein, such as the SLM apparatuses 500 and 600, discussed above. The SLM apparatus 900 includes a laser array 904 containing a plurality of lasers 912. The laser array 904 can be configured to form multiple independent part sections 902a, 902b. The lasers 912 can be selectively turned on and off which can result in independent melt pools with gaps 924 between the melt pools. The individual part section 902a, 902b can be integrally sintered together by the laser array 904 during a subsequent scan of the powder 908. The SLM apparatus 900 can be configured to form several parts 902a and 902b which are configured to remain independent after formation or which are intended to be coupled after formation. Further examples of SLM apparatuses are discussed below with reference to FIG. 10.

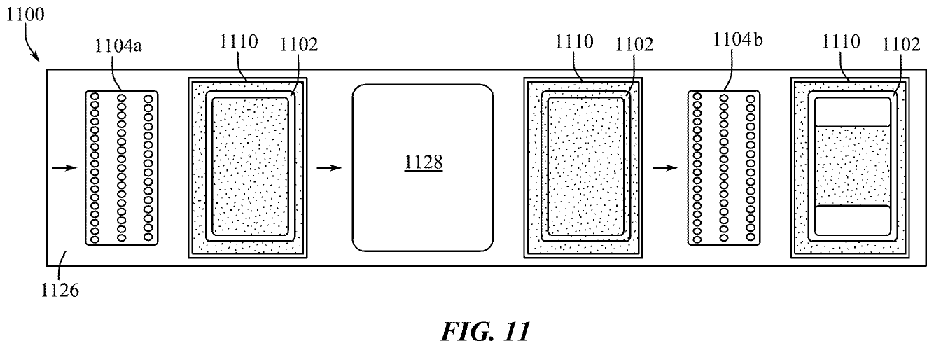

FIG. 10 illustrates top view of an SLM apparatus 1000. In certain aspects, the SLM apparatus 1000 can be substantially similar to, and can include some or all of the features of the SLM apparatuses described herein, such as the SLM apparatuses 500, 600, and 900, discussed above. The SLM apparatus 1000 can include a circular powder bed 1010 and laser array 1004 including multiple lasers, similar to any of the laser arrays described herein. The laser array 1004 can be positioned above the powder bed 1010 to direct radiation down onto powder 1008 in the powder bed 1010. The laser array can be configured to rotate about a center 1007 of the powder bed 1010. The laser array 1004 can have a length that is approximately equal to a radius of the powder bed 1010. The laser array 1004 can be configured to scan substantially all of the powder bed 1010 to rotating about the center 1007 of the powder bed. In some examples, additional powder 1008 can be spread on sintered portions without stopping rotation of the laser array 1004. Further details of SLM apparatuses are discussed below with reference to FIG. 11.

FIG. 11 illustrates a top view of an SLM production assembly 1100. In certain aspects, the process 1100 can include components that are substantially similar to, and can include some or all of the features of the SLM apparatuses described herein, such as the SLM apparatuses 500, 600, 900, and 1000, discussed above. The SLM production assembly 1100 can include one or more laser arrays 1104a, 1104b and one or more powder dispensers 1128 positioned over one or more powder beds 1110 on a conveyor belt 1126. As shown, the powder beds 1110 can include parts 1102 that can be in the process of being formed. The conveyor belt 1126 can move the powder beds 1110 under the one or more laser arrays 1104a, 1104b and powder dispensers 1128. In some examples, any apparatus or technique can be used to move one or more of the powder beds 1110, laser arrays 1104a, 1104b, and powder dispensers 1128. In some examples, the laser arrays 1104a, 1104b and the powder dispensers 1128 remain stationary as the conveyer belt 1126 moves the powder beds 1110.

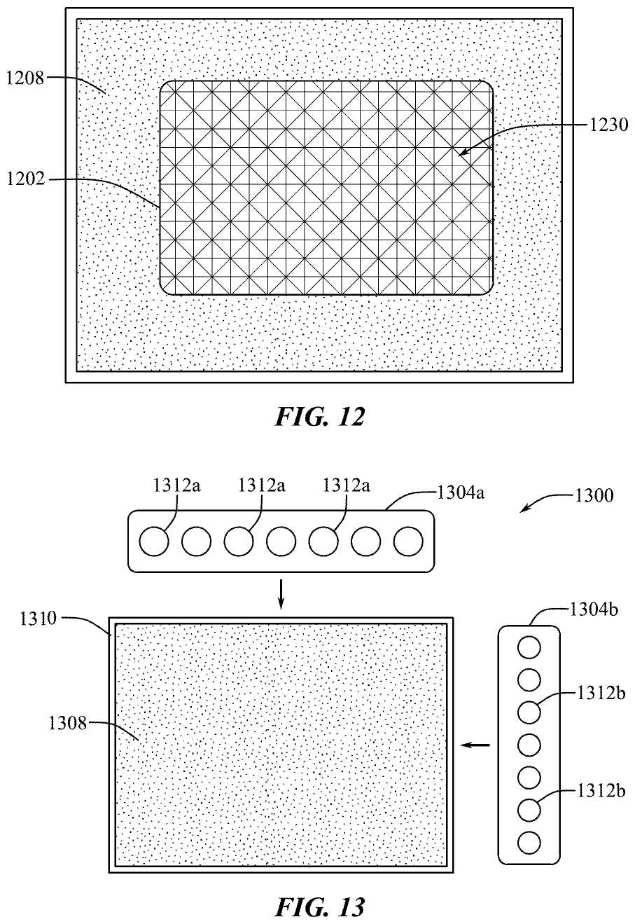

An example operation of the SLM production assembly 1100 will now be described. The powder bed 1110 positioned on the conveyor belt 1126 can pass underneath first laser array 1104a. The first laser array 1104a direct radiation onto the powder bed 1110 to form a portion of a part 1102. The powder bed 1110 then passes underneath the powder dispensers 1128. The powder dispensers 1128 dispensed powder onto the powder bed 1110 to cover the sintered portions of the part 1102 with powder. The powder bed 1110 then passes under a second laser array 1104b which sinters additional portions onto the part 1102. It will be understood that multiple powder beds 1110 can be positioned on the conveyor belt 1126 at a time. For example, a first powder bed can moving underneath a first laser array while a second powder bed, which previously moved under the first laser array passes underneath the powder dispensers, and simultaneously a third powder bed can be passing underneath a second laser array. It will further be understood that the SLM production assembly 1100 can include as many laser arrays and powder dispensers as are necessary to form the part in a single trip on the conveyor belt 1126. Further details of SLM apparatuses and systems are discussed below with reference to FIGS. 12 and 13.

FIG. 12 illustrates a top view of a part 1202 formed out of powder 1208 using the SLM methods described herein. In certain aspects, the part 1202 can be substantially similar to, and can include some or all of the features of the formed parts described herein, such as parts 602, 902, and 1102, discussed above. The part 1202 can include sweep patterns indicated with lines 1230 overlaid on the part 1202. The sweep patterns 1230 can be indicative of the path that a laser array took when forming the part 1202. For example, the part 1202 can include a horizontal sweep pattern, a vertical sweep pattern, and an angled sweep pattern. The multiple sweep patterns 1230 can results from multiple laser array configured to scan the powder 1208 along various axes. In some examples, the sweep patterns 1230 can result from a single laser array that scans the powder over several different directional paths. In some examples, the variation of intersecting sweep patterns can result in a strengthened configuration wherein the multi-directional sweep patterns interact to bind one another or leverage the varying orientation to add strength or other designed properties. Further details of SLM apparatuses are discussed below with reference to FIG. 13.

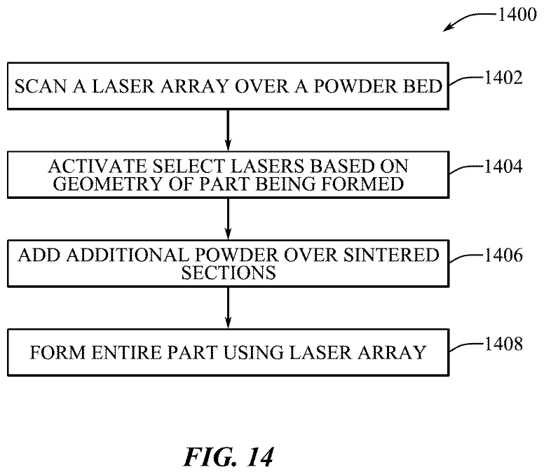

FIG. 13 illustrates a top view of an SLM apparatus 1300. In certain aspects, the SLM apparatus 1300 can be substantially similar to, and can include some or all of the features of the SLM apparatuses described herein, such as the SLM apparatuses 500, 600, 900, 1000, and 1100 discussed above. The SLM apparatus 1300 can include a first laser array 1304a including multiple first lasers 1312a and a second laser array 1304b including multiple second lasers 1312b. The SLM apparatus 1300 can also include a powder bed 1310 containing sinterable powder 1308 as described herein. In some examples, the first laser array 1304a can be orthogonal to second laser array 1304b. The first and second laser arrays 1304a, 1304b can be configured to scan a powder bed 1310. In some examples, the direction of motion of the first laser array 1304a is perpendicular to the direction of motion of the second laser array 1304b. It will be understood that the SLM apparatus 1300 could form sweep patterns on the formed part similar to those illustrated in FIG. 12 and described above. Further details of SLM processes are discussed below with reference to FIG. 14.

FIG. 14 illustrates a process flow diagram of a method 1400 for forming a part using the additive manufacturing processes and/or additive manufacturing described herein. At block 1402, a laser array can be scanned over a powder bed. The laser array can include multiple lasers as described herein. At block 1404, certain lasers within the laser array can be selectively activated based on the geometry of the part being formed and on the positioned of the laser within the array. Upon activating the lasers, radiation is directed onto powder within the powder bed to generate laser spots on the powder. The laser spots can form melt pools and/or can sinter the powder at the desired location. At block 1406, additional powder can be added over at least the sintered locations. This enables the laser array to again form laser spots and sinter powder above previously sintered powder locations to provide additional thickness to the part. At block 1408, an entire part is formed using the method 1400. Although illustrated as a separate step, it will be understood that block 1408 can occur as a result of any of the steps 1402, 1404, 1406. The additive nature of the method 1400 enables a complete and entire part to be formed solely from the powder. Additionally, detailed and complex features can be printed into the part, reducing or removing the need to machine the part.

To the extent applicable to the present technology, gathering and use of data available from various sources can be used to improve the delivery to users of invitational content or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, TWITTER® ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely prohibit the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not target to be exhaustive or to limit the embodiments to the precise forms disclosed. It will be apparent to one of ordinary skill in the art that many modifications and variations are possible in view of the above teachings.

What is claimed is:

1. A method of forming a part, comprising:
selectively activating lasers of a laser array comprising at least 100 lasers based at least in part on a geometry of the part;
scanning laser spots over a powder bed, the laser spots generated by the activated lasers; and
selectively sintering a powder contained in the powder bed with the laser spots to form the part.

2. The method of claim 1, wherein scanning the laser spots comprises moving the laser spots in a direction parallel to a common plane of the laser spots.

3. The method of claim 1, wherein the part is formed at a rate of greater than about 10,000 cm³/hour.

4. The method of claim 1, wherein scanning the laser spots comprises moving the powder bed relative to the laser spots.

5. The method of claim 1, wherein scanning the laser sports comprises moving the powder bed and the laser spots.

6. The method of claim 1, wherein the laser spots comprise two different spot sizes.

7. The method of claim 1, wherein the part comprises a housing for an electronic device.

8. The method of claim 1, wherein selectively sintering the powder comprises simultaneously forming multiple adjacent melt pools in the powder.

9. The method of claim 1, wherein the powder comprises at least one of steel, cobalt, chromium, aluminum, titanium, gold, platinum, silver, or ceramic.

10. The method of claim 1, wherein the powder comprises particles having an average major dimension between about 10 microns and about 200 microns.

11. An additive manufacturing system, comprising:
a laser array comprising 100 lasers;
a powder bed, at least one of the powder bed or a portion the laser array moveable relative to the other of the powder bed and the portion of the laser array; and
a controller to selectively activate a laser of the 100 lasers.

12. The system of claim 11, wherein the laser array generates laser spots, each laser spot having a spot size of about 20 microns to about 200 microns.

13. The system of claim 11, wherein the laser array has a collective output power of about 50 kilowatts to about 500 kilowatts.

14. The system of claim 11, wherein the laser array comprises three rows of laser heads.

15. The system of claim 11, wherein the laser array comprises a reflecting element to direct radiation generated by the laser to desired locations on the powder bed.

16. A 3D printer, comprising:
a powder bed; and
a laser array to selectively generate laser beams to form laser spots extending across a major dimension of the powder bed;
at least one of the powder bed or the generated laser beams being adjustable.

17. The 3D printer of claim 16, wherein the laser array comprises laser directing fiber optics.

18. The 3D printer of claim 16, wherein the laser array comprises between 100 and 1,000 lasers.

19. The 3D printer of claim 16, wherein a laser of the laser array is independently translatable relative to the powder bed to adjust a corresponding laser beam.

20. The 3D printer of claim 16, wherein the laser array comprises multiple rows of laser heads.
